(19) United States
(12) Patent Application Publication
(10) Pub. No.: US 2016/0186802 A1
(43) Pub. Date: Jun. 30, 2016

(54) VARIABLE-THROTTLE HYDROSTATIC BEARING

(71) Applicant: JTEKT CORPORATION, Osaka-shi (JP)

(72) Inventor: Takaaki HASHIMOTO, Nagoya-shi (JP)

(73) Assignee: JTEKT CORPORATION, Osaka-shi (JP)

(21) Appl. No.: 14/976,726

(22) Filed: Dec. 21, 2015

(30) Foreign Application Priority Data
Dec. 24, 2014 (JP) 2014-260917

(51) Int. Cl. F16C 29/02

(52) U.S. Cl. CPC F16C 29/025

(57) ABSTRACT

A variable-throttle hydrostatic bearing includes a diaphragm that faces a protruding portion via a predetermined gap and a discharge port formed in the protruding portion so as to communicate with a hydrostatic pocket, and adjusts a throttle amount based on the size of a gap between the diaphragm and the protruding portion. The variable-throttle hydrostatic bearing further includes a piston that contacts, at its first end, a surface on the opposite side of the diaphragm from a surface that faces the protruding portion, a cylinder that holds the piston such that the piston is slidable and forms a fluid chamber along with the piston, and a coil spring housed in the fluid chamber to press a second end of the piston.

### INCORPORATION BY REFERENCE

The disclosure of Japanese Patent Application No. 2014-260917 filed on Dec. 24, 2014 including the specification, drawings and abstract, is incorporated herein by reference in its entirety.

### BACKGROUND OF THE INVENTION

1. Field of the Invention

The invention relates to a variable-throttle hydrostatic bearing including a diaphragm-type variable throttle.

2. Description of Related Art

According to a related art, a variable-throttle hydrostatic bearing with a diaphragm-type variable throttle includes a variable throttle portion in a central portion of a surface of a diaphragm that is perpendicular to a direction in which the diaphragm is movable in order to enhance a vibration damping effect of the diaphragm to damp vibration of a fluid circuit including a hydrostatic pocket and the variable throttle. In the variable-throttle hydrostatic bearing, a gap representing a small clearance is formed between an outer peripheral portion of the diaphragm and a diaphragm holding member. The gap is filled with a hydrostatic fluid to suppress vibration of the diaphragm (see FIG. 7 of Japanese Patent Application Publication No. H10-196655 (JP H10-196655 A)).

Displacement of the diaphragm is highest in its central portion and low in its peripheral portion, and thus, in the related art described in JP H10-196655 A, the displacement in the peripheral portion of the diaphragm, which contributes to suppressing vibration, is low, possibly making production of a sufficient damping effect difficult.

### SUMMARY OF THE INVENTION

An object of the present invention is to provide a variable-throttle hydrostatic bearing with a diaphragm-type variable throttle that allows a desired damping capability to be easily achieved by arranging a damping mechanism at a desired position.

In an aspect of the present invention, a variable-throttle hydrostatic bearing includes:

a hydrostatic pocket formed in a bearing surface;

a fluid supply apparatus that supplies a fluid to the hydrostatic pocket;

a fluid channel forming a channel for a fluid, which extends from the fluid supply apparatus to the hydrostatic pocket; and

a variable throttle that is provided in a middle of the fluid channel and throttles a flow rate of the fluid to introduce the fluid into the hydrostatic pocket.

The variable throttle includes a fluid storage chamber, a fluid supply chamber with a protruding portion in its central portion, a diaphragm that partitions the fluid supply chamber from the fluid storage chamber and in which a surface of the diaphragm orthogonal to a thickness direction of the diaphragm faces the protruding portion via a predetermined gap, and a channel that is provided in the protruding portion and communicates with the hydrostatic pocket. The variable throttle adjusts a throttle amount using an opening degree of the gap between the diaphragm and the protruding portion.

The variable-throttle hydrostatic bearing further includes:

a piston that contacts, at its first end, a surface on the opposite side of the diaphragm from the surface that faces the protruding portion;

a cylinder that houses the piston such that the piston is slidable and forms a fluid chamber along with the piston; and

an elastic member that presses a second end of the piston and that is housed in the cylinder.

In the variable-throttle hydrostatic bearing in the above-described aspect, the cylinder may be closed at its first end, and a fluid in the fluid chamber flows into and out from the cylinder via a gap between the piston and an inner peripheral surface of the cylinder.

In the variable-throttle hydrostatic bearing in the above-described aspect, viscous resistance of the fluid flowing out from the fluid chamber hinders motion of the diaphragm in a direction away from the protruding portion. Thus, when the fluid circuit with the hydrostatic pocket and the variable throttle vibrates and the diaphragm vibrates in a thickness direction thereof, a damping effect is provided to prevent vibration of the diaphragm. The piston is separated from the diaphragm and can thus be arranged at a desired position on the surface on the opposite side of the diaphragm from the surface that faces the protruding portion. This allows a variable-throttle hydrostatic bearing that facilitates setting of the desired damping effect to be achieved.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a schematic diagram depicting a general configuration of a table feeding apparatus in the present embodiment;

FIG. 2 is a sectional view taken along line A-A in FIG. 1;

FIG. 3 is a detailed diagram of a variable throttle in a portion B in FIG. 2;

FIG. 4 is a detailed diagram of a piston portion;

FIG. 5 is a detailed diagram of a variable throttle in a variation; and

FIG. 6 is a diagram of the variable throttle as viewed in a direction of arrow C in FIG. 5.

### DETAILED DESCRIPTION OF EMBODIMENTS

An embodiment of the present invention will be described taking, as an example, a case where the present invention is used for a table feeding apparatus.

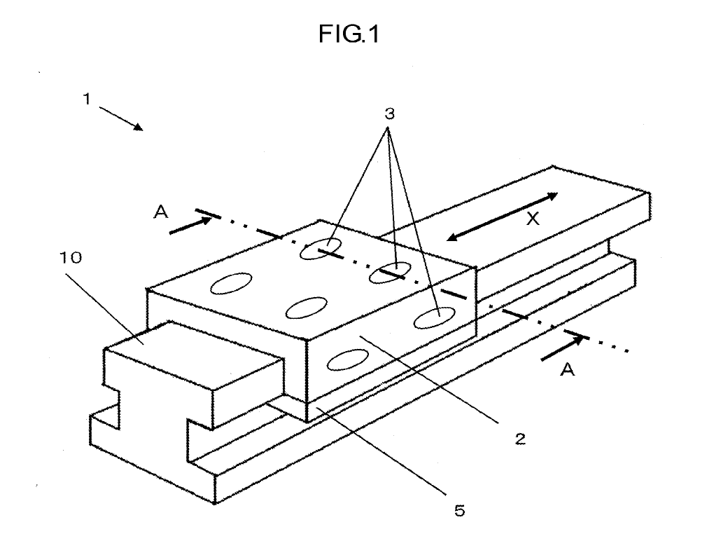

As depicted in FIG. 1, a table feeding apparatus 1 includes a table 2 slidably mounted on a slide portion of a base 10 and a pair of back plates 5 attached to lower portions of opposite ends of the table 2 such that the table 2 is movable only in an X axis direction.

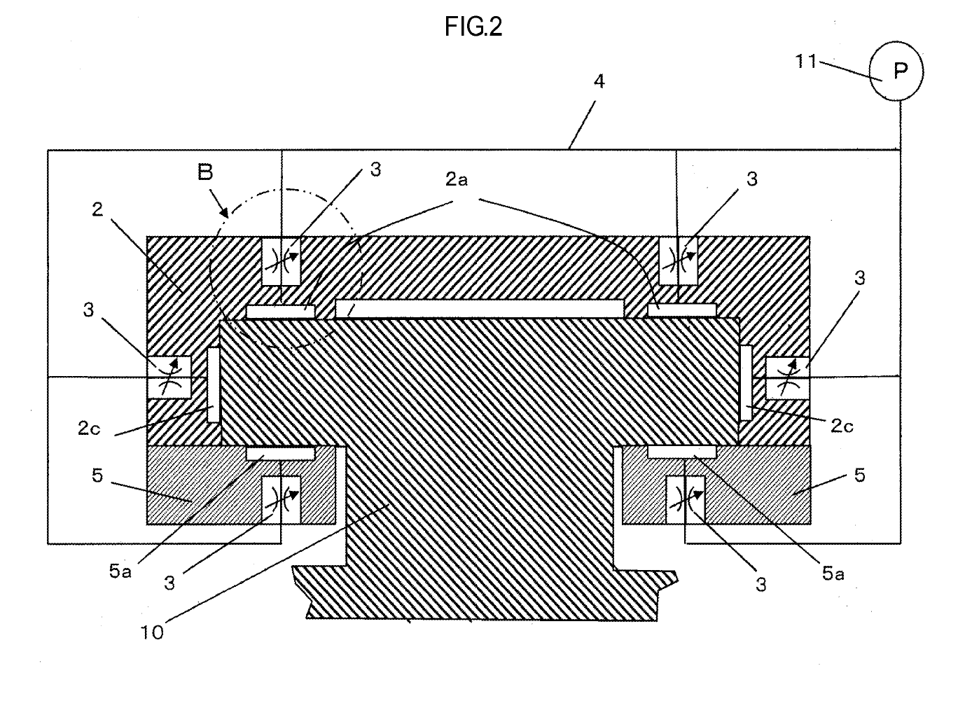

As depicted in FIG. 2, two hydrostatic pockets 2a are formed in a bearing surface of the table 2 that faces the base 10 such that the hydrostatic pockets 2a open downward. A pair of hydrostatic pockets 2c facing each other in a lateral direction is also formed in a bearing surface of the table 2. Variable throttles 3 are in communication with the hydrostatic pockets 2a and 2c. An oil feed line 4 is in communication with each of the variable throttles 3. A pump 11 (fluid supply apparatus) is coupled to the oil feeding line 4 to supply a fluid.

The back plates 5 also include hydrostatic pockets 5a open upward. The variable throttles 3 are in communication with the hydrostatic pockets 5a. The oil feed line 4 is in communication with each of the variable throttles 3.

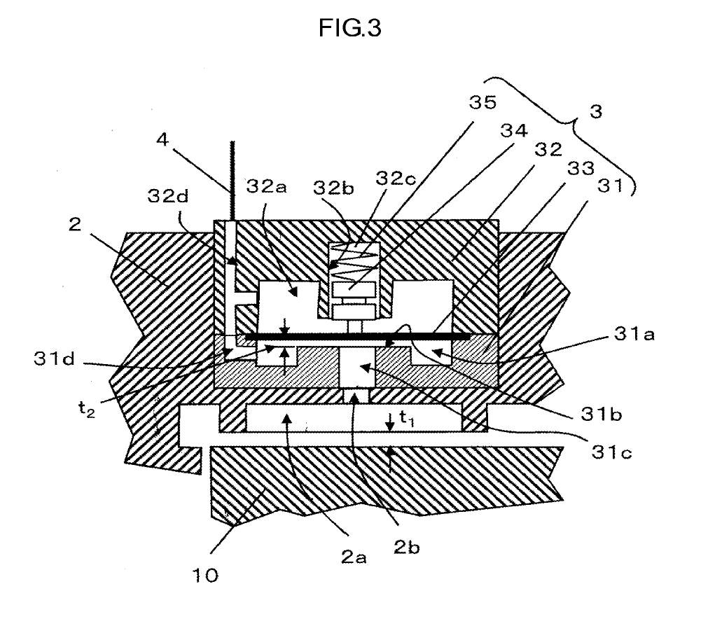

FIG. 3 depicts the variable throttle 3 in detail. The variable throttle 3 includes a variable throttle base 31 with a fluid supply chamber 31a and a cap 32 with a fluid storage chamber 32a such that the fluid supply chamber 31a and the fluid storage chamber 32a face each other and an outer peripheral portion of the diaphragm 33 is sandwiched between the variable throttle base 31 and the cap 32. The variable throttle base 31 includes a protruding portion 31b and a discharge port 31c both located in a central portion of the fluid supply chamber 31a. The cap 32 includes a cylinder 32b that is a cylindrical blind hole, in a central portion of the fluid storage chamber 32a. A piston 34 is slidably housed inside the cylinder 32b. A coil spring 35 is compressively arranged inside a fluid chamber 32c including the piston 34 and the cylinder 32b such that the piston 34 is pressed toward the diaphragm 33. This pressing force presses the piston 34 against the diaphragm 33.

When the diaphragm 33 is in a neutral position, the protruding portion 31b and the diaphragm 33 face each other via a gap t2. The oil feed line 4 is in communication with the fluid storage chamber 32a through a channel 32d formed in the cap 32. The oil feed line 4 is in communication with the fluid supply chamber 31a through a channel 31d formed in the variable throttle base 31 and the channel 32d. The discharge port 31c is in communication with the hydrostatic pocket 2a through an inflow passage 2b in the table 2.

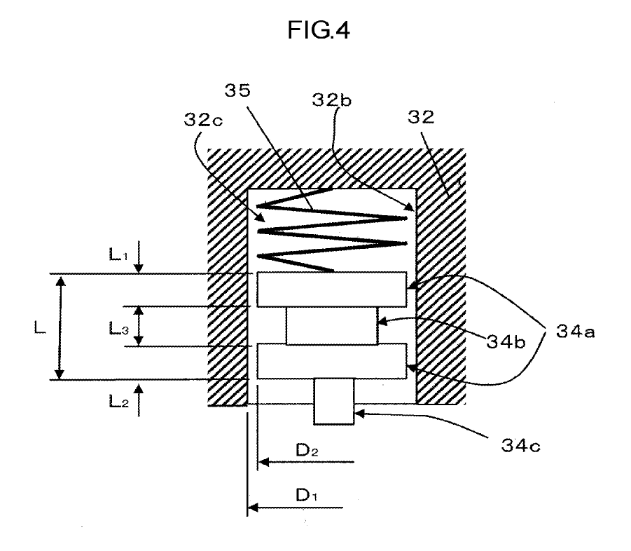

Details of the piston 34 will be described based on FIG. 4.

The piston 34 has a small-diameter portion 34b and large-diameter portions 34a arranged at opposite ends of the small-diameter portion 34b in its axial direction. The present embodiment includes two large-diameter portions 34a. The piston 34 further includes an end 34c that contacts the diaphragm 33. The two large-diameter portions 34a have a diameter D2. The small-diameter portion 34b has a diameter set at approximately 80% of the diameter D2 of the large-diameter portions 34a. The end 34c has a diameter set equal to or less than 50% of the diameter D2 of the large-diameter portions 34a. The large-diameter portion 34a farther from the end 34c has a length L1, and the large-diameter portion 34a closer to the end 34c has a length L2. The small-diameter portion 34b has a length L3.

Operations of the variable-throttle hydrostatic bearing will be described based on FIG. 3.

When a fluid is supplied through the line 4, the fluid storage chamber 32a is filled with the fluid having flown through the channel 32d. Moreover, the fluid chamber 32c is filled with the fluid having flown through the gap (throttle) between fitting portions of the cylinder 32b and the piston 34. On the other hand, the fluid supply chamber 31a is filled with the fluid having flown through the channel 32d and the channel 31d. The fluid in the fluid supply chamber 31a flows into the hydrostatic pocket 2a via a gap between the diaphragm 33 and the protruding portion 31b and the discharge port 31c. The fluid in the hydrostatic pocket 2a flows out through a gap between the hydrostatic pocket 2a and the base 10, which represents a clearance t1.

This also occurs in the hydrostatic pockets 2c open in a horizontal direction of the table 2 and in the hydrostatic pockets 5a in the back plate 5. As a result, the base 10 and the table 12 are held with the clearance t1 defined by each of the hydrostatic pockets 2a.

When the diaphragm 33 is displaced away from the protruding portion 31b, the diaphragm 33 pushes the piston 34, which is then pushed into the cylinder 32b to reduce the volume of the fluid chamber 32c. Consequently, the fluid flows out from the fluid chamber 32c via the gap (throttle) between the fitting portions of the piston 34 and the cylinder 32b. Thus, the piston 34 is subjected to a force that reduces a displacement rate of the piston 34 due to the viscous resistance of the fluid flowing between the fitting portions. The force is transmitted to the diaphragm 33, and a displacement rate of the diaphragm 33 is also reduced.

When a fluid circuit including the hydrostatic pockets and the variable throttles vibrates, the diaphragm 33 acts to vibrate, but the viscous resistance acts on the piston 34 so as to prevent the vibration. That is, the variable throttles provide a damping effect.

On the other hand, when the diaphragm 33 is displaced closer to the protruding portion 31b, a decelerating force acting on the piston 34 is not transmitted to the diaphragm 33. That is, the displacement rate of the diaphragm 33 is not reduced.

To enhance the damping effect, it is effective that when diaphragm 33 is displaced away from the protruding portion 31b, the diaphragm 33 and the piston 34 constantly contact each other, maximizing the time for which damping occurs. To achieve this, even when the diaphragm 33 is displaced closer to the protruding portion 31b, the piston 34 needs to be displaced in time for the displacement of the diaphragm 33. In this case, the vibration frequency of a vibration system including the piston 34 and the coil spring 35 may be set higher than the vibration frequency of the diaphragm 33, or the mass of the piston 34 and the pressing force of the coil spring 35 may be set such that the acceleration of the piston 34 is higher than the maximum acceleration of vibration of the diaphragm 33.

In the present embodiment, as depicted in FIG. 4, the small-diameter portion 34b having a diameter that is approximately 80% of the outer diameter D2 of the large-diameter portions 34a is provided in the center of the piston 34 in the axial direction, and the large-diameter portions 34a, producing a throttling effect, are arranged at the opposite ends of the small-diameter portion 34b. Thus, a desired throttling characteristic is achieved, and the operation of the piston 34 is made more stable. The throttling characteristic is determined using, as parameters, the size D1-D2 of a gap that is the difference between the bore diameter D1 of the cylinder 32b and the outer diameter D2 of the large-diameter portions 34a of the piston 34 and the sum L1+L2 of the lengths of the large-diameter portions 34a. On the other hand, when the piston 34 is tilted with respect to the cylinder 32b, the opposite ends of the large-diameter portions 34a come into contact with an inner wall of the cylinder 32b. A large tilt causes the piston to bite into the cylinder to preclude smooth motion of the cylinder. The degree of the tilt decreases with an increase in distance L between the opposite ends of the large-diameter portions 34a. The desired throttling characteristic and the stability of the operation of the piston 34 can both be achieved by setting the value of L3 such that L=L1+L2+L3, which is determined by the lengths L1+L2 of the large-diameter portions 34a at which the appropriate throttling characteristic can be achieved and the acceptable value of the tilt of the piston 34.

The diameter of the end 34c of the diaphragm 33 that contacts the diaphragm 33 is set equal to 50% or less of the diameter D2 of the large-diameter portions 34a. A small sectional area of the end 34c contributes to increasing the surface pressure of a contact portion between the piston 34 and the diaphragm 33 (the portion where the piston 34 and the diaphragm 33 contact each other), hindering formation of an oil film in the contact portion. The presence of an oil film causes a reduction in a force transmitted from the piston 34 to the diaphragm 33, degrading the damping effect. Thus, it is effective to reduce the diameter of the end 34c for preventing the damping effect from being degraded.

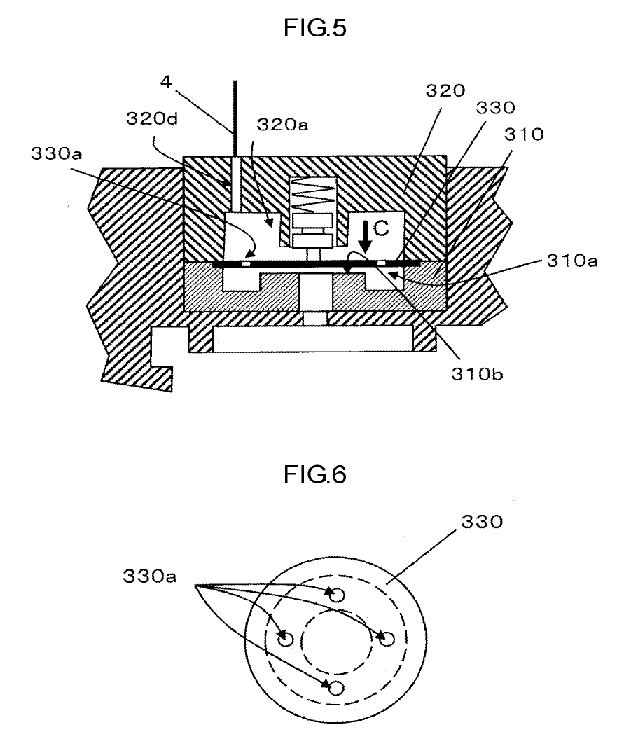

In the above-described embodiment, the fluid is supplied to the fluid supply chamber 31a via the channel 31d. As depicted in FIG. 5, channels 330a may be formed in portions of the diaphragm 33, which do not face a protruding portion 310b, such that the fluid is fed from a fluid storage chamber 320a to a fluid supply chamber 310a via the channels 330a. As depicted in FIG. 6, the channels 330a may be arranged on a circumference at regular intervals. This allows a channel in a variable throttle base 310 to be abolished, simplifying the structure.

In the above-described embodiment, the piston 34 is pressed by the coil spring 35. However, another elastic member such as rubber or an air spring may be used.

Reference numerals 310, 310a, 310b, 320, 320a, 320d, and 330 in FIG. 5 and FIG. 6 correspond to reference numerals 31, 31a, 31b, 32, 32a, 32d, and 33 in FIG. 3.

What is claimed is:

1. A variable-throttle hydrostatic bearing comprising:
a hydrostatic pocket formed in a bearing surface;
a fluid supply apparatus that supplies a fluid to the hydrostatic pocket;
a fluid channel forming a channel for a fluid, which extends from the fluid supply apparatus to the hydrostatic pocket;
a variable throttle that is provided in a middle of the fluid channel and throttles a flow rate of the fluid to introduce the fluid into the hydrostatic pocket,
the variable throttle comprising:
a fluid storage chamber;
a fluid supply chamber with a protruding portion in its central portion;
a diaphragm that partitions the fluid supply chamber from the fluid storage chamber and in which a surface of the diaphragm orthogonal to a thickness direction of the diaphragm faces the protruding portion via a predetermined gap, and
a channel that is provided in the protruding portion and communicates with the hydrostatic pocket,
the variable throttle adjusting a throttle amount using an opening degree of the gap between the diaphragm and the protruding portion,
a piston that contacts, at its first end, a surface on the opposite side of the diaphragm from the surface that faces the protruding portion;
a cylinder that houses the piston such that the piston is slidable and forms a fluid chamber along with the piston; and
an elastic member that presses a second end of the piston and that is housed in the cylinder.

2. The variable-throttle hydrostatic bearing according to claim 1, wherein
the cylinder is closed at its first end, and a fluid in the fluid chamber flows into and out from the cylinder via a gap between the piston and an inner peripheral surface of the cylinder.

3. The variable-throttle hydrostatic bearing according to claim 1, wherein
the piston includes large-diameter portions at opposite ends of a small-diameter portion in an axial direction.

4. The variable-throttle hydrostatic bearing according to claim 1, wherein
the first end of the piston has a smaller sectional area than the large-diameter portions of the piston.

5. The variable-throttle hydrostatic bearing according to claim 1, wherein
a portion of the diaphragm, which does not face the protruding portion, includes a channel that connects the fluid supply chamber and the fluid storage chamber.
